(19) United States
(12) Patent Application Publication
(10) Pub. No.: US 2007/0081078 A1
(43) Pub. Date: Apr. 12, 2007

(54) Synchronized video microscope

(76) Inventors: Eric Cummings, Livermore, CA (US); Kirsten Pace, Livermore, CA (US)

Correspondence Address: John H. Lynn, Suite C 103, 2915 Redhill Avenue, Costa Mesa, CA, 92626, US

(21) Appl. No.: 11/526,158

(22) Filed: Sep. 22, 2006

Related U.S. Application Data
(60) Provisional application No. 60/721,421, filed on Sep. 27, 2005.

(51) Int. Cl. H04N 7/18

(52) U.S. Cl. 348/79

(57) ABSTRACT

A video microscope for acquiring video images of a sample held within a sample holder comprises a stroboscopic illuminator for applying illumination to the sample when video images are to be acquired and a video camera arranged to acquire video images of the sample, the camera being movable within a housing. A real-time controller is arranged for controlling the stroboscopic illuminator and for controlling movement of the video camera, and a control system arranged to provide user configurable real-time video processing and video-event-based triggering.

### CROSS REFERENCE TO RELATED APPLICATION

Priority is claimed based on U.S. Provisional Application No. 60/721,421 for Synchronized Video Microscope.

### BACKGROUND OF THE INVENTION

This invention relates generally to microscopes and particularly to a microscope that includes a built-in video camera. Still more particularly, this invention relates to a video microscope that integrates a number of capabilities to make it useful as a research and lab automation tool for biology, microbiology, medical diagnostics chemical processing, microfluidics, MEMS, machine vision, and other fields where visualization and analysis of microscope images is utilized.

### SUMMARY OF THE INVENTION

The video microscope according to the present invention is a modular assembly that comprises a camera unit, an illuminator unit, a motorized traverse focus stage, a sample platform, a chassis, a front-panel, a control board, and real-time control, analysis, and video capture software. The microscope traverse is fully motorized, moving the camera module, but keeping the sample platform fixed with respect to the microscope housing.

The invention supports a plurality of position (x, y, and z or focus) and illumination-setting (intensity, color) presets that can be saved and instantly restored using the front panel or computer control software. This ability allows a user to navigate quickly between points of interest and return to previous locations.

Synchronization and stroboscopic techniques are supported using built-in video timing circuitry or external TTL triggering of four separate illuminator channels. External synchronization is supported by several selectable output TTL triggers, including composite video sync signals, odd/even video field signals, motor motion signals, and other camera specific trigger signals.

The control, analysis, and capture software automatically buffers the video signal, allowing the video of an event to be saved after an event occurs. The analysis software allows a user to select arbitrary polygonal shapes or individual points within the video to process in real time, for example for intensity, saturation, color, fluctuation, particle count, or velocity via particle image velocimetry (PIV). The user can add any combination of these probes to the real-time processing. The user can provide thresholds for actions based on the probe measurements. For example, the user can program the unit to adjust external apparatus, start recording video, move to a new location, or adjust the illumination when the intensity or velocity exceeds a threshold in a region of the flow.

### BRIEF DESCRIPTION OF THE DRAWINGS

FIG. 1 is a block diagram of the invention;

FIG. 2 is a perspective view of a synchronized video microscope according to the present invention;

FIG. 3 is a perspective view of a camera module that may be included in the invention;

FIG. 4 illustrates an optics box that may be included in the invention.

FIG. 5 illustrates an illuminator module that may be included in the invention;

FIGS. 6A and 6B illustrate a traverse stage that may be included in the invention;

FIGS. 7A and 7B illustrate a focus mechanism that may be included in the invention; and

FIGS. 8A and 8B illustrate a sample holder that may be included in the invention.

### DETAILED DESCRIPTION OF THE INVENTION

The video microscope 20 according to the present invention integrates a number of capabilities to make it useful as a research and lab automation tool for biology, microbiology, medical diagnostics chemical processing, microfluidics, MEMS, machine vision, and other fields where visualization and analysis of microscope images is utilized. The video microscope 20 is modular, comprising of a camera unit, illuminator unit, motorized traverse and focus stage, sample platform, chassis, front-panel, control board, and real-time control, analysis, and video capture software.

The microscope traverse is fully motorized, moving the camera module, but keeping the sample platform fixed with respect to the microscope housing. The video microscope 20 supports a plurality of position (x, y, and z or focus) and illumination-setting (intensity, color) presets that can be saved and instantly restored using the front panel or computer control software. This ability allows a user to navigate quickly between points of interest and return to previous locations.

Synchronization and stroboscopic techniques are supported using built-in video timing circuitry or external TTL triggering of four separate illuminator channels. External synchronization is supported by several selectable output TTL triggers, including composite video sync signals, odd/even video field signals, motor motion signals, and other camera specific trigger signals.

The video microscope 20 includes control, analysis, and capture software automatically that buffers the video signal, allowing the video of an event to be saved after an event occurs. The analysis software allows a user to select arbitrary polygonal shapes or individual points within the video to process in real time, for example for intensity, saturation, color, fluctuation, particle count, or velocity via particle image velocimetry (PIV). The user can add any combination of these probes to the real-time processing. The user can provide thresholds for actions based on the probe measurements. For example, the user can program the unit to adjust external apparatus, start recording video, move to a new location, or adjust the illumination when the intensity or velocity exceeds a threshold in a region of the flow.

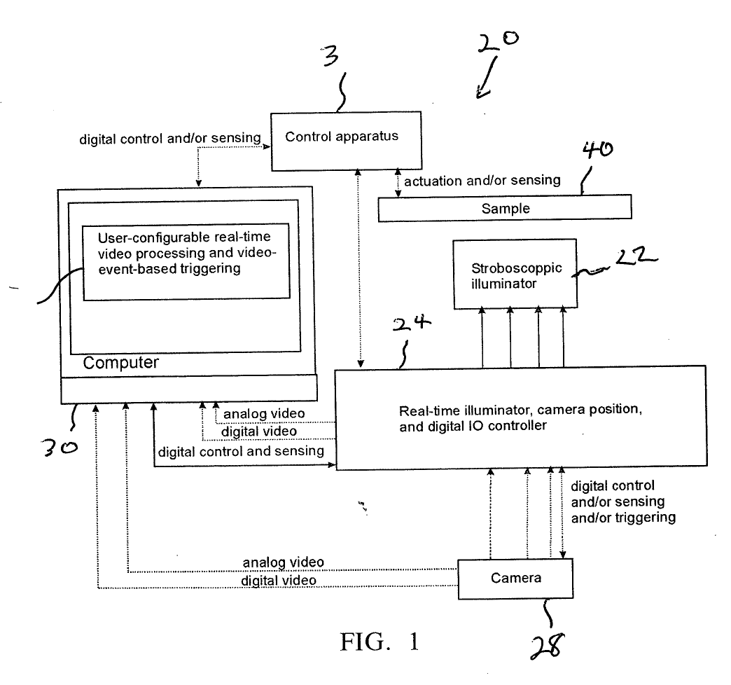

Referring to FIGS. 1-3, the synchronized video microscope (SVM) 20 according to the present invention is a miniature computer-controllable inverted fluorescence microscope with a motorized x, y, and z traverse module 24, a four-channel stroboscopic illuminator 22 and an external synchronization triggering module. Dotted lines in FIG. 1 indicate optional connections and signal pathways.

The invention includes a video camera 28 that can be an analog video camera or a digital video camera. The camera 28 can supply synchronization signals to the real-time controller 24; the real-time controller can extract video sync signals from an analog video signal; or the real-time controller 24 can operate asynchronously from the camera 28.

The video signal can go to the computer 30 via a direct digital video connection, direct analog video connection, or through an analog or digital connection via the real-time controller 24. The computer 30 provides user-configurable real-time video processing and video event-based triggering.

The real-time controller 24 can strobe the channels of the illuminator 22 independently running an arbitrary sequence of the following real time instructions (these instructions are representative and not intended to be limiting):
Wait for even field (if interlaced)
Wait for odd field (if interlaced)
Wait for horizontal sync
Wait for new frame
Wait for external digital input
Wait for preset time
Turn on channel {A, B, C, and/or D}
Turn off channel {A, B, C, and/or D}
Turn on Mark signal
Turn off Mark signal
Turn on external digital output
Turn off external digital output
Increment counter
Decrement counter
Perform arbitrary arithmetic on counter
Set counter
Move to position
Move by increment
Move at velocity
Conditionally go to instruction
Unconditionally go to instruction
Call subroutine

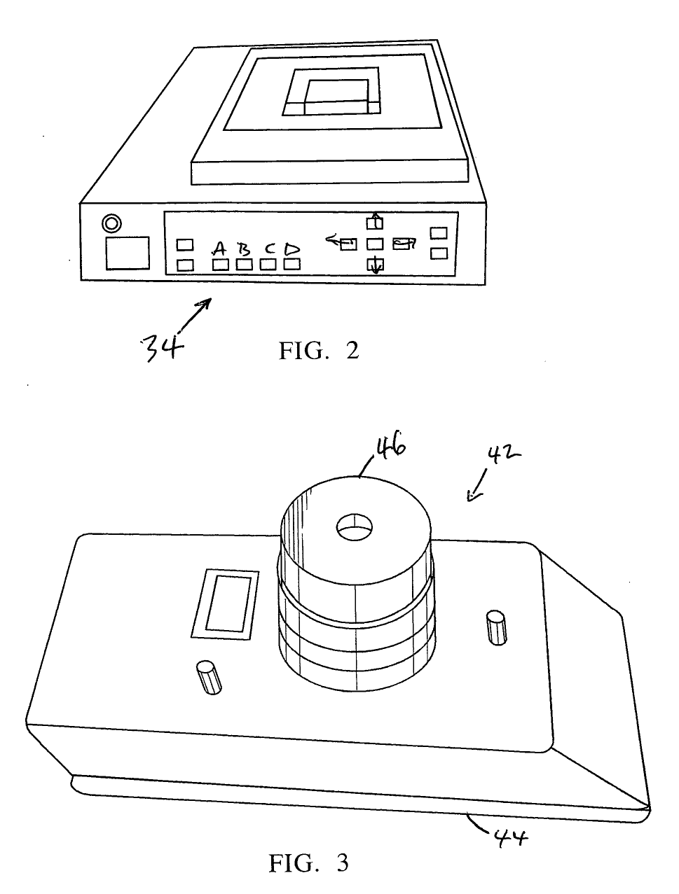

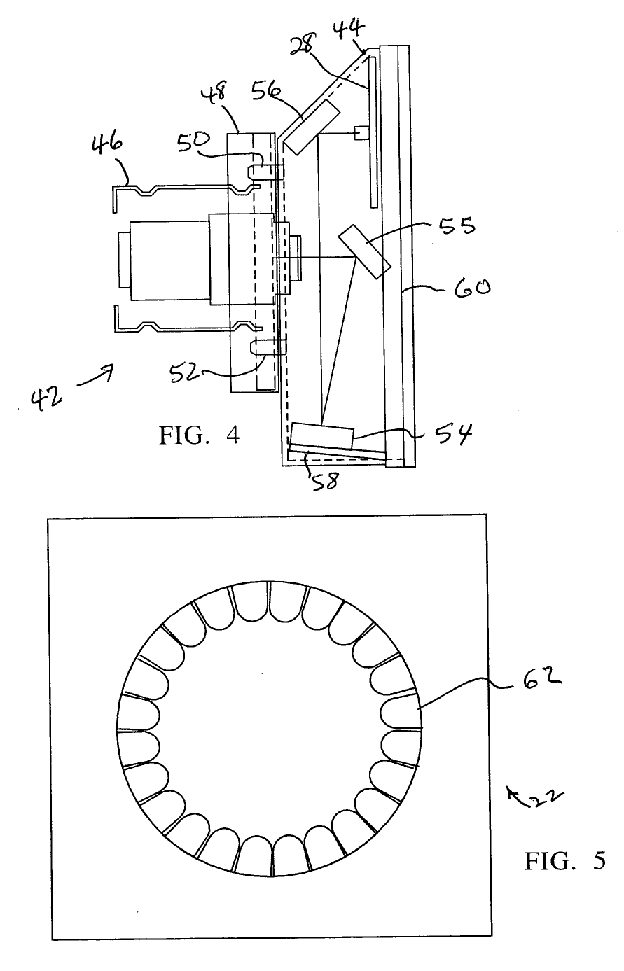

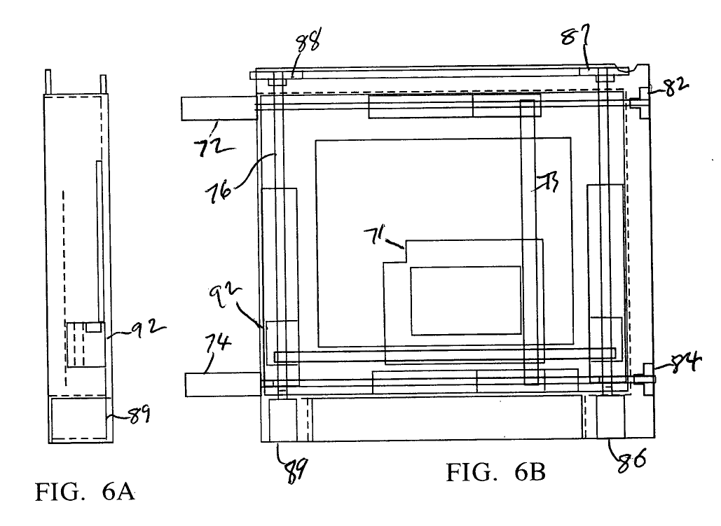

Thus the real-time controller 24 can sequence its motion synchronously or asynchronously with the video and illuminator setting. Each illuminator channel can be controlled through the real-time controller 24 or directly via an external digital input. The real-time controller 24 settings including illuminator sequence programming, motion control and position, camera operation, digital outputs, and digital input/output modes can be controlled via a digital link to the computer 30 and/or via a front-panel 34, shown in FIG. 2. The computer 30 can read status data and measurements from the real-time controller 24.

The computer software can measure one or more of the following quantities on one or more user-defined points or regions, on specific color bands or on the gray scale:
Displacement or velocity via image cross-correlation techniques
Pixel statistics, including the mean, minimum, maximum, root-mean-square, mode, etc.
Particle statistics, including count, size, number density, size distribution, etc.
   The computer software can also poll the controller for measurements such as digital input state, etc. These measurements can be buffered or streamed to disk.

Different event conditions such as thresholds can be optionally applied to one or more of these real-time measurements. One or more different actions can be performed in real-time when one or more event conditions are satisfied. Such actions include but are not limited to: starting or stopping video acquisition, taking a still image, starting the averaging of a still image, stopping the averaging of a still image, executing a program, issuing one or more commands to the real-time controller, issuing one of more commands to external apparatus, playing a warning tone, generating a page, phone call, email, message, or instant message, changing the illuminator settings, moving the motion stage, etc. In this fashion, the real-time video processing is able to provide real-time automated control of an experiment, data acquisition, etc.

Automatic illuminator setting changes when taking a still image or averaged still image. For example, this allows a sample 40 to be minimally illuminated or illuminated with a non-photo-bleaching or non-perturbative light except while acquiring or averaging an image, thereby minimizing photo-bleaching or other unwanted light-related perturbations.

Averaging occurs as a result of depressing a key or button and saving the picture when the button is released.

Automated raster scans by speed, displacement, synchronous or asynchronous with the illuminator, video signal, or digital input.

A preset includes the x, y, and z position of the stage and the illuminator settings.

Camera Module

A compact camera module 42 contains the complete optical hardware for the microscope and detector. This unit plugs into a motorized traverse and focus stage 48. Held by magnets, camera modules can be readily swapped without any tools to change options, for example to change the camera type between black and white, color, high resolution, low light, and high speed cameras; to change internal components like fluorescence emission filters; or to change the magnification. Electrical interconnections with a printed circuit board on the x-y traverse assembly are made via gold-plated electrodes.

The optics box 44 houses the video camera 28 and the microscope objective 46. The optics box 44 is attached to the traverse stage 48 via magnets, so it is easy to change optics systems. Alignment pins 50 and 52 on the optics box 44 aid in the quick alignment with the traverse stage.

The small size of the optics box is achieved using three first-surface mirrors 54-56. The mirror alignment is adjusted using two screws backside of the optics box, which move a plate 58 housing the mirror 54. The video camera 28 is attached to the lid 60 of the optics box 44 and is sealed to keep lint and stray light off the optics systems.

The camera module 28 contains a serial EEPROM with which the control board can communicate to detect automatically the type of camera, video signal, and camera-specific triggering formats that the camera supports.

The present invention supports black and white video, color composite video, and color S-Video formats. Because these formats can be decoded by the control board, no camera-specific triggering is used. A mark signal allows the control board to strobe an internally mounted LED. This strobe signal appears uniformly in the camera image and can be used to provide a positive time stamp for absolute time synchronization.

Illuminator Module

An illuminator 22 for the microscope also plugs into the traverse and focus stage. This illuminator may have four separately triggerable illuminator channels, A, B, C, and D. These separate channels drive various light-emitting diode combinations to produce a desired illumination color, intensity, strobe pattern, etc. The illuminator is held in place by a friction connector and can be readily swapped, for example, to change the LED color settings. A ring of 24 LEDs 62 point radially inward along a shallow cone to provide concentrated illumination at the focus of the microscope objective. Channels A and B control 8 LEDs a piece distributed evenly around the circle. Channels C and D control 4 evenly distributed LEDs a piece. A typical fluorescence illuminator comprises of high-brightness ultraviolet, blue, or green LED diodes on channels A, B, and D, and a white LED illuminator on channel C. A typical color illuminator comprises of red, green, blue, and white LEDs on the four channels. The illuminator can be mounted at two different heights with respect to the traverse stage by plugging the illuminator into electrical sockets on the printed circuit board on the x-y traverse assembly in two orientations (0 and 90 degrees) to support imaging of thick samples that require extra standoff distance. The present invention also provides a connector for an externally mounted four-channel LED illuminator if needed.

The LEDs in the illuminator module preferably are driven via a pair of high-current inverters. The current-limiting resistor can be adjusted for the bandgap and efficiency of different LEDs

Motorized Traverse and Focus Stage

The illuminator and camera modules traverse left and right (x) by 50 mm, front and back (y) by 75 mm, and focus (z) by 9 mm. The x and y traverse are integrated with a sheet metal stage. The traverse mechanism in both directions comprises of two motorized lead screws on opposite sides of the stage that are synchronized using a sprocket and chain. Only one gear-reduction motor is needed to turn both lead screws, but because of the relative inexpensiveness of the motor compared to a custom rotary and thrust bearing, one gear-reduction motor is preferred for each screw. This arrangement also eliminates much of the tension in the synchronizing chain. The motors are connected to the control board through a flexible multi-conductor cable. Travelers on the lead screws are joined by a press-fit rigid ground rod. The cross-stage rod for both the x and y directions pass through orthogonal and non-intersecting holes (stacked in the z direction) in an x-y traveler assembly that holds electronic connectors and magnets to link with the camera module, the illuminator module, and the control board. The connection to the chassis-mounted control board is via a flat flex cable that supports the large range of motion of the x-y traveler. When the twin lead screws turn in one direction, the traveler follows the cross-stage rod for that direction and slides along the cross stage rod of the other traverse. One traveler in each direction has a magnet that attracts the slide of a precision linear slide potentiometer mounted on the stage. These potentiometers provide absolute position feedback information to the control board via a flexible cable.

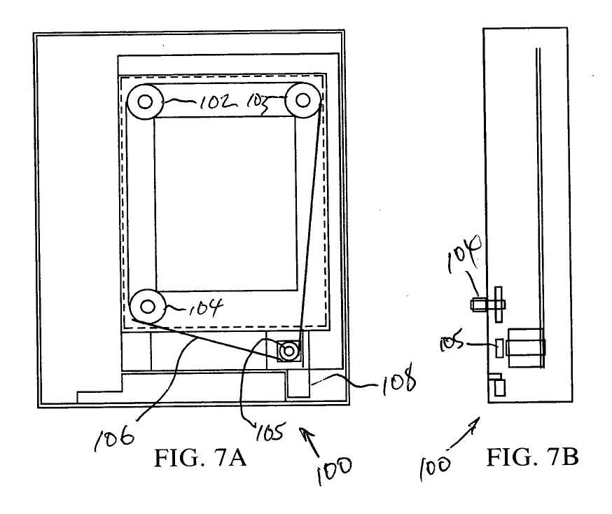

Referring to FIGS. 7A and 7B, the traverse stage 71 is translated in the x and y directions via turn screws. Motors 72 and 74 is coupled to each turn screw to motorize the travel. The motors are attached to the focus stage to prevent movement of the motor. The turn screws for each direction are synchronized via chain and sprockets 79 and 80. The sprockets 79 and 80 are attached to the end of the turn screws. To couple the turn screws to the x-y traverse, a traveler is threaded onto each turn screw. The travelers for the y direction house a precision rod mounted perpendicular to the direction of motion. This precision rod passes through the traverse stage, providing no restriction in the x direction movement while precisely controlling the y direction motion.

Smooth travel of the traverse stage is achieved by preventing the travelers from moving in the z direction. The travelers are also used to track the precise location of the traverse stage. Two potentiometers are attached to the focus stage, to track the x and y directions. One traveler for each direction is coupled to the potentiometer via magnet.

Referring to FIGS. 7A and 7B, the focusing mechanism 100 is a kinematic mount comprising of three fine-pitch lead screws threaded into bushings that are adhesively bonded or otherwise held to the topside of the cover of the microscope chassis. Each lead screw is bonded of otherwise held to a sprocket 102-104 and a disk magnet at the base. These magnets are attracted to the top of the traverse stage through a layer of Teflon or other friction-reducing film or to other magnets that are bonded or otherwise held to the top surface of the traverse stage to hold the stage firmly against the lead screws. Two or three springs provide an additional force to return the traverse stage into magnet-stage or magnet-magnet contact with the lead screws if the stage momentarily breaks contact because, for example, excessive downward force is applied. These springs slide over posts that pass loosely through holes in the traverse stage. These posts prevent the traverse stage from moving out of range of a kinematic arrangement of magnets that slide up and down two orthogonal vertical walls of the chassis, constraining the traverse stage to a precisely defined x and y position with respect to the chassis while allowing unconstrained vertical movement of the entire traverse stage. A thin layer of Teflon or a similar antifriction coating on these vertical walls and/or the magnets facilitates smooth focus motion. A precision linear potentiometer is mounted vertically on the main control board at the rear wall of the SVM 20. The slide of this potentiometer is connected via a simple bracket to a horizontal magnet that is attracted to a flare on the traverse, providing absolute focus position feedback to the control board.

The sprockets 102-104 on the fine adjustment screws are connected via a chain 106 to a fourth sprocket 105 that is mounted on a gear-reduction motor 108. This motor 108 is connected to a sheet metal assembly that slides up and down a post on the top cover. This assembly applies a gentle preload to the chain 106 and via magnets, is held firmly to the top of the focus stage in a free-sliding manner such that motor deflections produced by the chain tension do not produce side forces on the traverse. This partial uncoupling of the focus motor from the traverse stage prevents lateral shifts in the observed image when microscope focus adjustments are made.

As described previously focus of the SVM 20 is controlled using three ultra-fine screws attached to the SVM cover via threaded bushings. The focus screw tips are fitted with magnets that maintain contact between the screw tips and the focus stage. Three standoffs are pressed into the cover, which maintains alignment between the cover and focus. The standoffs also house springs that provide an upward force on the focus stage to maintain the contact with the magnets.

The focus screws are synchronized via a chain and sprocket system. Each focus screw has a pressed-on sprocket. A fourth smaller sprocket is connected to a motor, which provides the motorized focusing system of the SVM 21. The sprocket on the motor is smaller to allow a high torque ratio for the focus system. The motor is connected to a attach plate that is held adjacent to the focus stage via magnets. Additional magnets are placed between the attach plate and the chassis to allow the focus system to slide vertically along the chassis but prevents the motor from turning.

The absolute position of the focus stage is tracked via a potentiometer on the main control board. The potentiometer arm is magnetically held to the focus stage.

A traveler printed circuit board provides interconnections between the illuminator module, camera module, and control board via friction connectors, gold-plated surface pads, and a flat flex cable, respectively.

Sample Platform

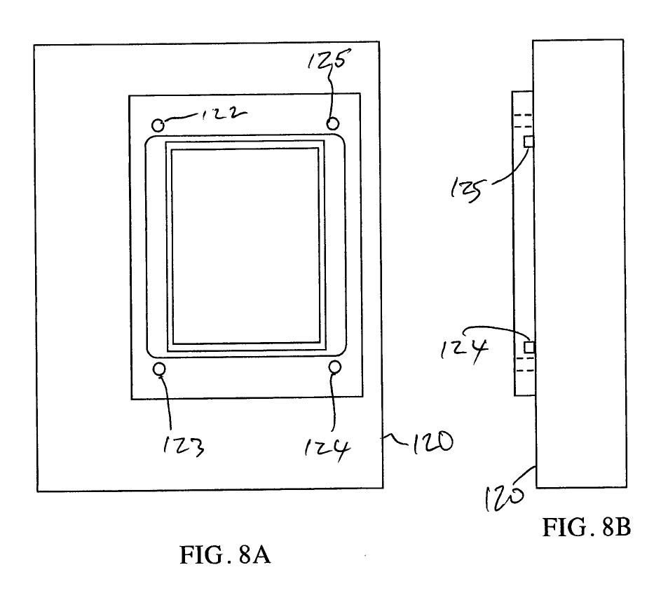

Referring to FIGS. 8A and 8B, the sample platform 120 is removable, held to the top cover by press-fit magnets. In a preferred embodiment this platform is made of Delrin or a similar easily machinable and chemically resistant material. It features a flush mounted stainless steel insert to facilitate mounting a sample. This insert can be removed and the platform machined readily to facilitate incorporation of a custom fixture. The x-y-z position and rotation of this platform is fixed by placing the platform over four shouldered posts 122-125 in the cover. Three of these posts 122-125 double as the focus-adjustment screws.

Chassis

The sheet-metal chassis holds the power supply, optional fan, front-panel, control board, back-panel connectors, mounting hardware or feet and cover. As described before it contains orthogonal vertical walls to guide the traverse stage. It is designed for stiffness and coated for chemical resistance. In a preferred embodiment, the chassis is coated with Teflon. The base of the chassis has removable rubber feet. With the feet removed, the SVM 21 can be conveniently mounted on off-the-shelf optical posts on an optical table.

Front Panel

The front panel contains controls for power, presets, and command mode. In “site” mode, arrow buttons control motion in all directions, buttons lettered A, B, C, and D set and move to presets and a “stop” button immediately stops all motion. In “light” mode, the buttons lettered A, B, C, and D select and deselect the respective illuminator channels (indicated by the back-light LED brightness), the up and down arrows causes the illumination of the selected channels to increase and decrease respectively by a factor (plus a low initial value if a selected channel was previously turned off), “stop” turns off the selected channels, and the focus controls work as usual. Buttons have yellow LED back illumination to guide the user and give visual feedback. The LED brightness is either high, dim, or off. High indicates that a button is active; dim indicates that a button is enabled. Off indicates that a button is disabled. Pressing and holding down a button has various intuitive effects. In “site” mode, briefly pressing A, B, C, or D causes the SVM to move and switch the illumination to the respective preset. Pressing and holding down A, B, C, or D for more than approximately a second (until the yellow illuminating LED that glowed brightly when the button was first pressed returns to a dim state) causes the current position and illumination state to be stored to the respective preset. In “site” mode, pressing the arrow and focus buttons briefly causes the microscope to move slowly in the particular direction. Pressing and holding an arrow or focus button causes the microscope to move slowly for approximately 1 s, then accelerate over the course of ˜2 s to a maximum speed, allowing fine adjustments and coarse adjustments to be made using the same controls. In “light” mode, holding the up and down arrows cause the selected channels to fade up or down in intensity. In all modes, a “lock” LED glows green when the SVM is in place and red when the SVM is moving. This panel communicates with the control board via a flexible cable. The front panel functions and communications are implemented on a flash microcontroller whose firmware can be field upgraded via this communications link.

A control board handles communications and commands from the front panel, external triggering, video signal buffering and synchronization-signal extraction, illuminator control, motor control, and position sensing. A programmable logic device is used to switch the signals delivered to two back-panel output triggers programmably between: an even/odd video field indicator, a video composite sync signal, one of four programmable trigger outputs, a motion indicator, a camera-specific trigger output for use in coordinating the SVM with external apparatus.

These trigger signals appear on the rear panel of the SVM along with the video signals and illuminator trigger signals/external LED driver. The illuminator channels can alternatively be directly triggered using the trigger inputs A, B, C, and D.

The control board has connections including an RS232 serial link, a front-panel communications link via a ribbon cable, and a link to the traverse assembly via a flat flex cable that includes video, camera communications and triggering, and illuminator triggering signals, as well as power and ground circuits.

The microcontroller on the control board applies a PWM signal and direction signal to an H-bridge device to drive the motors on each of the three axes. The outputs of the H bridges go via a ribbon-cable connector to the motors on the motorized traverse stage.

Video synchronization signals are extracted from buffered RS170 analog video signal, if present. Otherwise the triggering signals for synchronizing the illuminator strobe and external apparatus must be generated directly by the camera module.

Microscope Control, Analysis, and Recording Software

The real-time analysis capabilities of the software used with the video microscope 20 make the microscope a powerful software-configurable detector. Arbitrary polygonal regions and discrete points can be probed in real time for image statistics, particle count, and velocity via particle image velocimetry. These probe measurements can be streamed to a spreadsheet file or embedded (with or without audio annotation) into the standard-format video file. Each of the probes can independently trigger a different set of actions, e.g., recording, stopping recording, pausing recording, setting hardware triggers, moving the microscope, changing to a location/illumination preset, software triggering external apparatus, sounding an alarm, logging an event and/or measurement, or running a program when thresholds are crossed.

Live or saved video can be analyzed in real time. Arbitrary polygonal regions and/or points can be analyzed for image statistics or velocity via particle image velocimetry (PIV). These arrangements of probes can be saved to disk and opened. These measurements can be streamed to a spreadsheet file and can individually trigger different software and hardware actions.

A variety of scientific look up tables can be applied to convert gray-scale intensity data into formats that are better for observing detail and quantitatively reproducing.

A spectral lookup table (LUT) helps to bring out detail.

A novel sinusoidal look up table creates a synthetic interferogram or contour plot, which brings out detail and can be quantitatively reproduced.

The software provides controls for selecting the digital trigger output types.

The software also allows one to configure the precise durations and delays of the various illuminator channels. Stroboscopic sequences are performed via running interpreted sequences within the SVM 20 in real time. These sequences can be involved, e.g., producing multiple illumination pulses per video frame. The complexity of the sequence is limited only by the available RAM in the microcontroller at one or two bytes per instruction. Available instructions include: await, set timer, reset, SetLEDs and go to and other sequence instructions. The arguments of the await instruction can be even field, odd field, timer, or any of the video or external input trigger signals or a logical combination of the two, e.g. await even field or odd field or timer waits for the first of these events and then goes on to the next step. The arguments of SetLEDs are A, B, C, or D, and any logical combination, e.g., SetLEDs A, B, C sets channels A, B, and C, and turns off channel D. Because these instructions are interpreted and the firmware is fully updatable, these instruction sets can be extended arbitrarily as needed. For example, pulse counters and motion commands can readily be integrated. Alternatively, the sequence could be compiled within uScope and programmed directly in a fast compiled format into the SVM firmware.

What is claimed is:

1. A video microscope for acquiring video images of a sample held within a sample holder, comprising:
a stroboscopic illuminator for applying illumination to the sample when video images are to be acquired;
a video camera arranged to acquire video images of the sample, the camera being movable within a housing;
a real-time controller arranged for controlling the stroboscopic illuminator and for controlling movement of the video camera; and
a control system arranged to provide user configurable real-time video processing and video-event-based triggering.
